(19) United States
(12) Patent Application Publication
(10) Pub. No.: US 2026/0082472 A1
(43) Pub. Date: Mar. 19, 2026

(54) CONTROL TERMINAL, DEVICE CONTROL SYSTEM, CONTROL METHOD, AND RECORDING MEDIUM

(71) Applicant: Panasonic Intellectual Property Management Co., Ltd., Osaka (JP)

(72) Inventors: Kazuma NISHIYASU, Nara (JP); Yuta TOMIO, Osaka (JP); Kosuke KAMEDA, Osaka (JP)

(21) Appl. No.: 19/303,001

(22) Filed: Aug. 18, 2025

(30) Foreign Application Priority Data
Sep. 19, 2024 (JP) 2024-161900

(51) Int. Cl. H05B 47/155; H05B 47/19

(52) U.S. Cl. CPC H05B 47/155; H05B 47/19

(57) ABSTRACT

A control terminal includes: a wireless communicator that communicates with a plurality of lighting fixtures; a receiver that receives, from a user, a setting related to identification information indicating a group to which the plurality of lighting fixtures are to belong or control content to be instructed to the plurality of lighting fixtures; and an information processor that, when the plurality of lighting fixtures include an unset lighting fixture to which the setting has not been applied and the information processor instructs the plurality of lighting fixtures to participate in a first control to be performed by specifying the identification information, (a) instructs the plurality of lighting fixtures to participate in the first control by using the wireless communicator and further (b) instructs the unset lighting fixture to participate in same control as the first control by using the wireless communicator.

### CROSS REFERENCE TO RELATED APPLICATION

The present application is based on and claims priority of Japanese Patent Application No. 2024-161900 filed on September 19, 2024.

### TECHNICAL FIELD

The present disclosure relates to a control terminal included in a device control system.

### BACKGROUND ART

There has been known a technique of controlling a lighting device (lighting fixture) by wireless communication. Japanese Unexamined Patent Application Publication No. 2023-82166 discloses a lighting system that can control a plurality of lighting devices individually and manage their control collectively.

### SUMMARY

When a plurality of lighting fixtures are grouped and the identification information of the group is set in the plurality of lighting fixtures, a control terminal that controls the plurality of lighting fixtures by wireless communication can control the plurality of lighting fixtures as a group by transmitting, to the plurality of lighting fixtures, control information in which the identification information of the group is specified. However, when this setting has not been applied in a lighting fixture in which the identification information of the group should be set, the lighting fixture will be excluded from the target of the control to be performed as a group.

The present disclosure provides a control terminal and the like that can include, as a target of control, a device in which a setting related to identification information to be used for the control has not been applied.

A control terminal according to the one aspect of the present disclosure includes: a wireless communicator that communicates with a plurality of devices; a receiver that receives, from a user, a setting related to identification information indicating a group to which the plurality of devices are to belong or control content to be instructed to the plurality of devices; and an information processor that, when the plurality of devices include an unset device to which the setting has not been applied and the information processor instructs the plurality of devices to participate in a first control to be performed by specifying the identification information, (a) instructs the plurality of devices to participate in the first control by using the wireless communicator and further (b) instructs the unset device to participate in same control as the first control by using the wireless communicator.

A device control system according to one aspect of the present disclosure includes: the control terminal described above; and the plurality of devices.

A control method according to one aspect of the present disclosure is a control method executed by a control terminal that communicates wirelessly with a plurality of devices; receiving, from a user, a setting related to identification information indicating a group to which the plurality of devices are to belong or control content to be instructed to the plurality of devices; and when the plurality of devices include an unset device to which the setting has not been applied and the plurality of devices are instructed to participate in a first control to be performed by specifying the identification information, (a) instructing the plurality of devices to participate in the first control through wireless communication and further (b) instructing the unset device to participate in same control as the first control through the wireless communication.

A recording medium according one aspect of the present disclosure is a non-transitory computer-readable recording medium having a program recorded thereon for causing the control terminal to execute the control method described above.

The present disclosure can achieve a control terminal and the like that can include, as a target of control, a device to which a setting related to the identification information to be used for the control has not been applied.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram illustrating a functional configuration of a device control system according to an embodiment.

FIG. 2 is a diagram conceptually illustrating a mesh network.

FIG. 3 is a sequence diagram illustrating an example of setting operations for an area and a scene.

FIG. 4 is a diagram illustrating an example of area information.

FIG. 5 is a diagram illustrating an example of scene information.

FIG. 6 is a diagram illustrating an example of setting management information.

FIG. 7 is a flowchart illustrating an example of area control.

FIG. 8 is a flowchart illustrating an example of scene control.

FIG. 9 is a flowchart illustrating an example of combined control.

FIG. 10 is a sequence diagram illustrating a variation of the area control.

FIG. 11 is a sequence diagram illustrating a variation of the scene control.

### DETAILED DESCRIPTION

The following specifically describes one or more embodiments with reference to the drawings. Note that each of the one or more embodiments described below shows a general or specific example. The numerical values, shapes, materials, structural elements, the arrangement and connection of the structural elements, steps, the processing order of the steps, etc. shown in the following one or more embodiments are mere examples, and are not intended to limit the scope of the present disclosure. In addition, among the structural elements in the following one or more embodiments, structural elements not recited in any one of the independent claims are described as optional structural elements.

Note that the figures are schematic diagrams and are not necessarily precise illustrations. Moreover, configurations that are essentially the same share like reference signs in the figures, and overlapping explanations thereof may be omitted or simplified.

### Embodiment

### Configuration

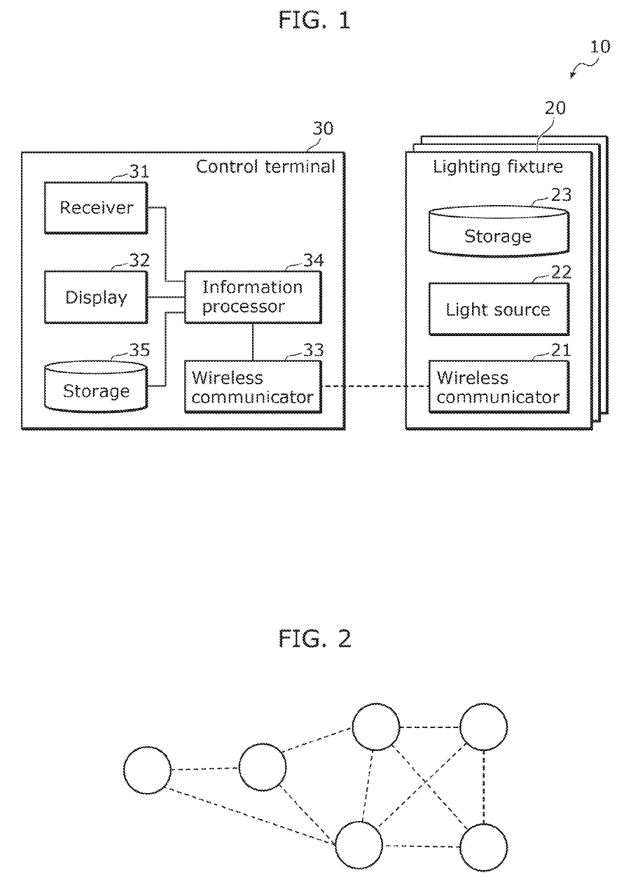

First, a configuration of a device control system according to an embodiment will be described. FIG. 1 is a block diagram illustrating a functional configuration of the device control system according to the embodiment. As illustrated in FIG. 1, device control system 10 includes a plurality of lighting fixtures 20 and control terminal 30. Each of the plurality of lighting fixtures 20 is an example of a device to be controlled in device control system 10.

In device control system 10, each of the plurality of lighting fixtures 20 has wireless communication functionality, and the plurality of lighting fixtures 20 form a wireless mesh network (hereafter, also referred to simply as a mesh network). The wireless mesh network is an example of a wireless communication network.

FIG. 2 is a diagram conceptually illustrating the mesh network. Each circle mark in FIG. 2 corresponds to one lighting fixture 20 (i.e., a communication node). In a mesh network, when information is transmitted from one communication node (also referred to as a first communication node) to another communication node (also referred to as a second communication node), the information is transmitted through routing, for example, but may be transmitted by other methods such as flooding.

The information transmitted over the mesh network is control information for controlling lighting fixture 20 to turn on, turn off, or dim, for example. Moreover, when an environmental sensor is included in the mesh network as described later, a measurement value (sensing information) of the environmental sensor may be transmitted.

First, lighting fixture 20 will be described. Lighting fixture 20 is a base light provided on the ceiling of an indoor space to illuminate the indoor space. As described above, each of the plurality of lighting fixtures 20 has wireless communication functionality, and the plurality of lighting fixtures 20 form the mesh network. Note that the form of lighting fixture 20 is not particularly limited, and may be a ceiling light, a downlight, a spotlight, or the like. Specifically, each lighting fixture 20 includes wireless communicator 21, light source 22, and storage 23.

Wireless communicator 21 is a wireless communication circuit for lighting fixture 20 to communicate wirelessly (more specifically, over radio waves) with other lighting fixtures 20 and control terminal 30. After lighting fixture 20 joins the mesh network, wireless communicator 21 performs communication over the mesh network described above. Moreover, before lighting fixture 20 joins the mesh network, wireless communicator 21 periodically transmits a beacon signal (sometimes called an advertising signal or the like) and individually communicates wirelessly with control terminal 30 that receives the beacon signal. Specifically, wireless communicator 21 communicates wirelessly in accordance with a communication standard such as Bluetooth (registered trademark) Low Energy (BLE) or Bluetooth (registered trademark) mesh.

Light source 22 emits white light into the indoor space to illuminate the indoor space by lighting fixture 20. Light source 22 is implemented by, for example, a light-emitting diode (LED) element, but may be implemented by other light-emitting elements such as a semiconductor laser, an organic electro-luminescence (EL) element, or an inorganic EL element.

Storage 23 is a storage device that stores various information necessary for the operation of lighting fixture 20, such as setting information described later. Storage 23 is implemented by, for example, a semiconductor memory.

Next, a configuration of control terminal 30 is described. Control terminal 30 is an information terminal used by a user to make settings (initial settings and settings change) related to the mesh network and controlling lighting fixtures 20. Control terminal 30 is, for example, a mobile terminal such as a smartphone, a tablet terminal, or a personal digital assistant (PDA). Control terminal 30 may also be a dedicated remote controller used in device control system 10. Specifically, control terminal 30 includes receiver 31, display 32, wireless communicator 33, information processor 34, and storage 35.

Receiver 31 receives user operations. Specifically, receiver 31 is implemented by a touch panel or the like.

Display 32 displays various images. Display 32 is implemented by, for example, a display panel such as a liquid crystal panel or an organic EL panel.

Wireless communicator 33 is a wireless communication circuit for control terminal 30 to communicate wirelessly (more specifically, over radio waves) with each of lighting fixtures 20. Specifically, wireless communicator 33 communicates wirelessly in accordance with a communication standard such as BLE.

Information processor 34 processes information in response to a user operation received by receiver 31. Information processor 34 is implemented by, for example, a microcomputer, but may be implemented by a processor or a dedicated circuit. The functions of information processor 34 are implemented by executing a computer program (software) stored in storage 35 by hardware, such as the microcomputer or processor, included in information processor 34.

Storage 35 is a storage device that stores information necessary for information processing, such as a computer program executed by information processor 34. Storage 35 is implemented by, for example, semiconductor memory. In storage 35, for example, identification information of lighting fixtures 20 included in the mesh network and the location information of lighting fixtures 20 are stored (registered).

### Area and Scene Setting Operations

Control terminal 30 can group lighting fixtures 20 and can instruct control to be performed as a group. Control terminal 30 can reduce the number of instances of communication by transmitting control information in which the identification information indicating the group is designated as a destination. Hereinafter, an area will be described as an example of a group of the plurality of lighting fixtures 20, the identification information indicating the group will be referred to as area identification information, and control of lighting fixtures 20 using the area identification information will be referred to as area control.

Moreover, control terminal 30 can set identification information indicating a scene for the content of control for lighting fixtures 20. Control terminal 30 can reduce the amount of communication by transmitting, to lighting fixtures 20, control information in which the scene identification information is specified, instead of control information including specific command values corresponding to the content of control. Hereinafter, identification information indicating a scene is referred to as scene identification information, and control of lighting fixtures 20 using the scene identification information is also referred to as scene control.

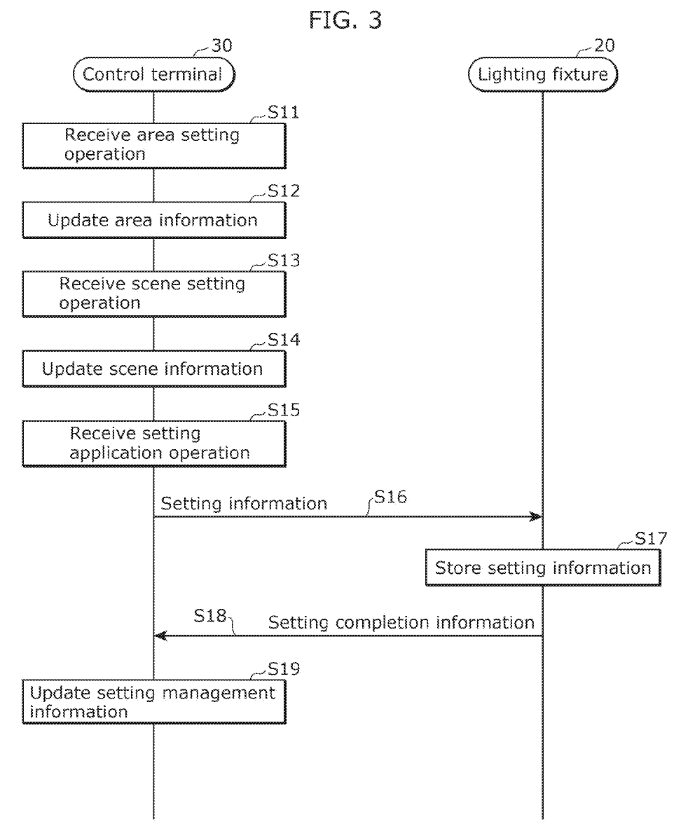

To perform area control and scene control, a user needs to make an area setting (setting related to area identification information) and a scene setting (setting related to scene identification information) for lighting fixtures 20 and control terminal 30. The following describes setting operations for the area and the scene performed by control terminal 30 based on user operations. FIG. 3 is a sequence diagram illustrating an example of setting operations for an area and a scene. Note that FIG. 3 illustrates an example of setting an area for a given lighting fixture 20 and then setting a scene for that area. In this example, control terminal 30 and the given lighting fixture 20 are connected via communication.

A user performs an area setting operation for setting an area, and receiver 31 of control terminal 30 receives the area setting operation (S11). The area setting operation includes an operation of specifying the area identification information (for example, the area number such as area 1) in which the given lighting fixture 20 currently connected via communication is to belong. In other words, in step S11, it can be said that receiver 31 receives a setting related to the area identification information.

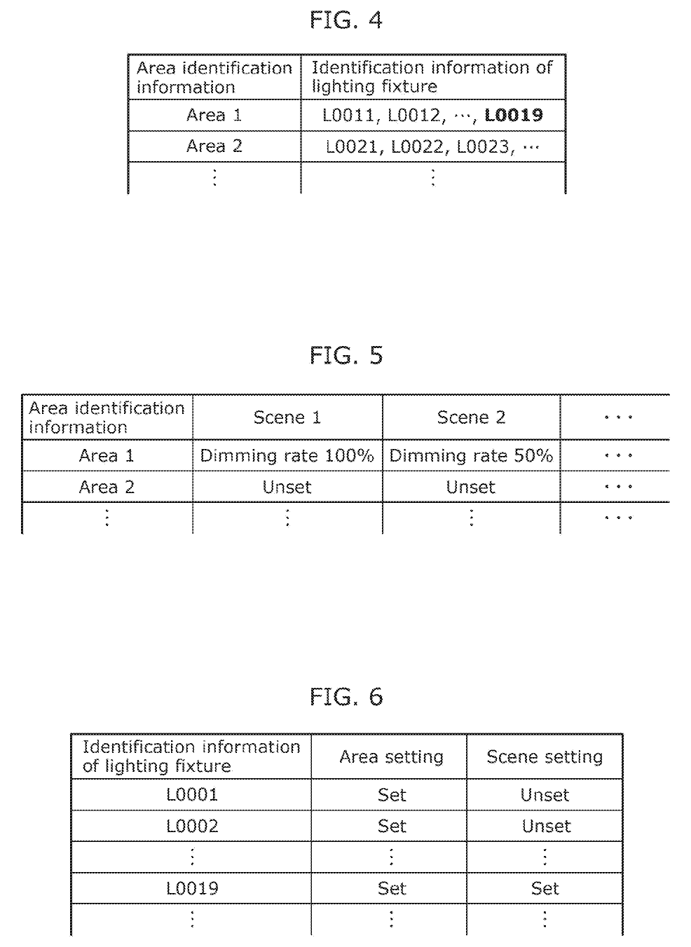

When the area setting operation is received, information processor 34 updates the area information stored in storage 35 (S12). FIG. 4 is a diagram illustrating an example of area information. In the area information, the area identification information is associated with the identification information of lighting fixture 20 belonging to the area. For example, in step S11, when an operation of adding lighting fixture 20 with identification information L0019 to area 1 is performed, L0019 is added to the identification information of lighting fixture 20 associated with area 1 in area information. With this, the area setting of lighting fixture 20 is applied in control terminal 30. Note that one lighting fixture 20 may belong to a plurality of areas.

Next, the user performs a scene setting operation for setting a scene, and receiver 31 of control terminal 30 receives the scene setting operation (S13). The scene setting operation includes an operation of specifying the area identification information and the control content for each item of scene identification information (for example, scene number such as scene 1) for controlling lighting fixture 20 that belongs to the area. In other words, in step S13, it can be said that receiver 31 receives a setting related to the scene identification information.

When the scene setting operation is received, information processor 34 updates the scene information stored in storage 35 (S14). FIG. 5 is a diagram illustrating an example of scene information. In the scene information, the area identification information is associated with content of control for each item of the scene identification information (for example, scene number such as scene 1) for controlling lighting fixture 20 belonging to the area. For example, in step S13, when the operation of setting a scene for area 1 is performed, the content of control for each scene for area 1 is added. With this, the scene setting in area 1 is applied in control terminal 30. Note that the scene (control content) does not have to be different for each area, and the scene may be independent of areas and common to all lighting fixtures 20.

Next, the user performs a setting application operation to set the content of the area setting and the content of the scene setting for lighting fixture 20 (applying the settings in lighting fixture 20), and receiver 31 receives the setting application operation (S15). When the setting application operation is received, information processor 34 transmits, by using wireless communicator 33, setting information to lighting fixture 20 to which the settings should be applied (S16).

Wireless communicator 21 of lighting fixture 20 receives the setting information. Lighting fixture 20 stores the received setting information in storage 23 (S17), and wireless communicator 21 transmits setting completion information to control terminal 30 (S18).

Wireless communicator 33 of control terminal 30 receives the setting completion information. Information processor 34 updates the setting management information stored in storage 35 based on the received setting completion information (S19). FIG. 6 is a diagram illustrating an example of setting management information. For example, when the content of the area setting and the content of the scene setting are transmitted to lighting fixture 20 with identification information L0019 and the setting completion information is received successfully, in step S19, each of the area setting and the scene setting of lighting fixture 20 with identification information L0019 is changed from “Unset” to “Set”. Note that, when the setting completion information is not received due to a communication error, each of the area setting and the scene setting for lighting fixture 20 with identification information L0019 remains "Unset".

In addition, when the setting completion information for lighting fixture 20 with identification information L0019 is received and its area setting and scene setting are changed to “Set”, and then the area setting and the scene setting for lighting fixture 20 with identification information L0019 are changed by receiver 31 of control terminal 30, each of the area setting and the scene setting for lighting fixture 20 with identification information L0019 is changed from "Set" to "Unset". In other words, the setting management information indicates whether the settings of lighting fixture 20 held by control terminal 30 match the settings held by lighting fixture 20.

As described above, the user can set the area setting in lighting fixture 20 belonging to the mesh network using control terminal 30. In addition, the user can set the scene in lighting fixture 20 belonging to the mesh network by using control terminal 30.

### Example of Area Control

The user can perform area control such as turning on lighting fixture 20 belonging to area 1 by using control terminal 30. Here, there may be cases where the area setting is applied in the area information (FIG. 4) stored in storage 35 of control terminal 30 but is not applied in one or more lighting fixtures 20. Specifically, there may be cases where the user forgot to perform the setting application operation in step S15 in FIG. 3, or where the setting information transmitted in step S16 has not reached one or more lighting fixtures 20 due to communication error, etc.

As a result, even when the user provides an instruction to perform the area control with the intention of causing lighting fixture 20 belonging to area 1 to turn on, this may cause a situation where one or more lighting fixtures 20 to which the area setting has not been applied will not turn on.

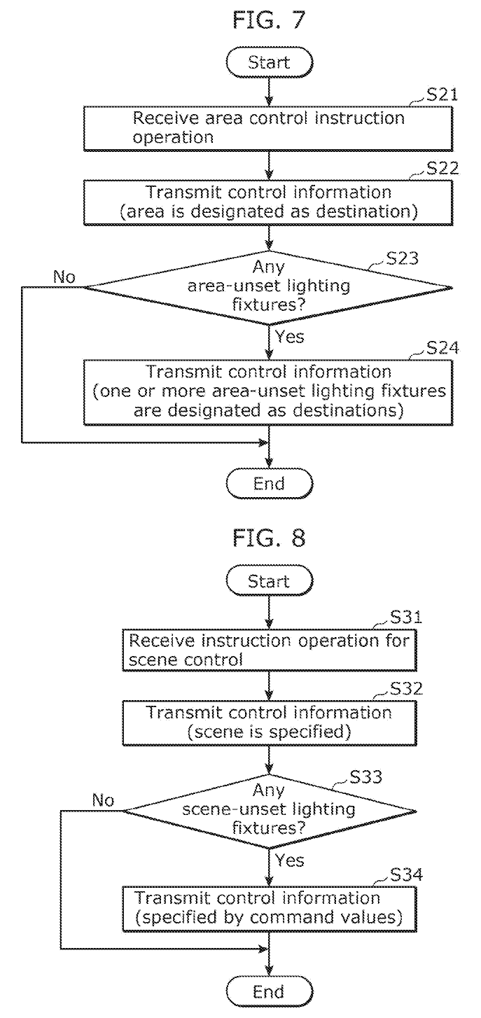

Therefore, control terminal 30 uses the setting management information to perform processing for causing lighting fixture 20 to which the area setting has not been applied to participate in the area control. An example of such area control will be described below. FIG. 7 is a flowchart illustrating an example of area control.

The user performs an area control instruction operation to provide an instruction for area control, and receiver 31 of control terminal 30 receives the area control instruction operation (S21). The area control instruction operation includes specifying the area identification information (e.g., area 1) and specifying the control content (e.g., turning on). Hereinafter, a specified area may also be referred to as a target area, and specified control content may also be referred to as target control.

When an area control instruction operation is received, information processor 34 transmits, by using wireless communicator 33, control information (control information in which the target control content is specified by a command value) for performing target control, with a target area designated as a destination (S22). Note that, in the control information with the target area designated as the destination, the area identification information of the target area is specified.

As a result, lighting fixtures 20 belonging to the target area basically emit light (or stop emitting light) according to the content of the target control. However, even when a given lighting fixture 20 is indicated to belong to the target area in the area information but the area setting has not been applied to the given lighting fixture 20, the given lighting fixture 20 will not emit light (or stop emitting light) according to the content of the target control.

Therefore, information processor 34 determines whether there are any lighting fixtures 20 to which the area setting has not been applied (hereinafter, also referred to as one or more area-unset lighting fixtures) (S23). Specifically, information processor 34 determines whether lighting fixtures 20 belonging to the target area in the area information (FIG. 4) stored in storage 35 include one or more lighting fixtures 20 in which the area has not been set in the setting management information (FIG. 6).

When information processor 34 determines that there are no area-unset lighting fixtures (No in S23), the operation ends. On the other hand, when information processor 34 determines that there are one or more area-unset lighting fixtures (Yes in S23), information processor 34 individually transmits, by using wireless communicator 33, control information for causing the one or more area-unset lighting fixtures to perform the same control as the target control, with the one or more area-unset lighting fixtures designated as destinations (S24). As a result, the one or more area-unset lighting fixtures belonging to the target area emit light (or stop emitting light) according to the content of the target control.

As described above, when a plurality of lighting fixtures 20 subject to the area control include one or more area-unset lighting fixtures, which are one or more lighting fixtures to which the area setting has not been applied, and control terminal 30 (information processor 34) instructs the plurality of lighting fixtures 20 to participate in the area control to be performed by specifying the area identification information, control terminal 30 (information processor 34) instructs the plurality of lighting fixtures 20 to participate in the area control by using wireless communicator 33 (S22) and further instructs the area-unset lighting fixture to participate in the same control as the area control by using wireless communicator 33 (S24).

With this, control terminal 30 can cause lighting fixtures 20 belonging to the target area to emit light (or stop emitting light) according to the content of the target control, regardless of whether the area setting has been applied to lighting fixtures 20. In other words, control terminal 30 can achieve the area control as intended by the user.

### Example of Scene Control

The user can perform scene control, which is control that, for example, the user can cause the plurality of lighting fixtures 20 to emit light (stop emitting light) based on the control content of scene 1 by using control terminal 30. Here, there may be cases where the scene setting is applied to the scene information (FIG. 5) stored in storage 35 of control terminal 30 but has not been applied to one or more lighting fixtures 20. Specifically, there may be cases where the user has forgot to perform the setting application operation in step S15 in FIG. 3, or where the setting information transmitted in step S15 has not reached one or more lighting fixtures 20 due to communication error, etc.

As a result, even when the user provides an instruction to perform scene control with the intention of causing lighting fixtures 20 to emit light (or stop emitting light) based on the control content of scene 1, this may cause a situation where one or more lighting fixtures 20 to which the scene setting has not been applied will not emit light (or stop emitting light).

Therefore, control terminal 30 uses the setting management information to perform processing for causing lighting fixture 20 to which the scene setting has not been applied to participate in the scene control. An example of such scene control will be described below. FIG. 8 is a flowchart illustrating an example of scene control. Note that, in the following, the scene in the scene information (FIG. 5) is common to all lighting fixtures 20, and is not different for each area.

The user performs an instruction operation to provide an instruction for scene control, and receiver 31 of control terminal 30 receives the instruction operation for scene control (S31). The instruction operation for scene control includes specifying a plurality of lighting fixtures 20 subject to the control and specifying scene identification information (e.g., scene 1). Hereinafter, the specified lighting fixtures 20 may also be referred to as target lighting fixtures, and specified scene may also be referred to as a target scene.

When an instruction operation for the scene control is received, information processor 34 transmits, by using wireless communicator 33, control information (in other words, control information in which the identification information of the target scene is specified) for performing the scene control, with the target lighting fixtures designated as destinations (S32). As a result, the target lighting fixtures basically emit light (or stop emitting light) according to the content of the target scene. However, one or more target lighting fixtures to which the scene setting has not been applied will not emit light (or stop emitting light) according to the content of the target scene.

Therefore, information processor 34 determines whether there are any lighting fixtures 20 to which a scene setting has not been applied (hereinafter, also referred to as one or more scene-unset lighting fixtures) (S33). Specifically, information processor 34 determines whether lighting fixtures 20 specified as target lighting fixtures in step S31 include one or more lighting fixtures 20 in which a scene has not been set in the setting management information (FIG. 6).

When information processor 34 determines that there are no scene-unset lighting fixtures (No in S33), the operation ends. On the other hand, when information processor 34 determines that there are one or more scene-unset lighting fixtures (Yes in S33), information processor 34 individually transmits, by using wireless communicator 33, control information for performing the same control as in the target scene by command values (instead of the scene identification information), with the one or more scene-unset lighting fixtures designated as destinations (S34). As a result, the one or more scene-unset lighting fixtures emit light (or stop emitting light) according to the content of the target control.

As described above, when the plurality of lighting fixtures 20 subject to the scene control include one or more scene-unset lighting fixtures, which are lighting fixtures to which the scene setting has not been applied, and control terminal 30 (information processor 34) instructs the plurality of lighting fixtures 20 to participate in the scene control to be performed by specifying the scene identification information, control terminal 30 (information processor 34) instructs the plurality of lighting fixtures 20 to participate in the scene control by using wireless communicator 33 (S32) and further instructs the scene-unset lighting fixture to participate in the same control as the scene control by using wireless communicator 33 (S34).

With this, control terminal 30 can cause the plurality of lighting fixtures 20 to emit light (or stop emitting light) according to the content of the target control, regardless of whether the scene setting has been applied in the plurality of lighting fixtures 20. In other words, control terminal 30 can achieve the scene control as intended by the user.

### Example of Combined Control

A user can perform combined control of the area control and the scene control, such as causing one or more lighting fixtures 20 belonging to area 1 to emit light (stop emitting light) according to scene 1 by using control terminal 30. Here, there may be cases where the area setting is applied in the area information (FIG. 4) stored in storage 35 of control terminal 30 but has not been applied in one or more lighting fixture 20. Moreover, there may be cases where the scene setting is applied in the scene information (FIG. 5) stored in storage 35 of control terminal 30 but has not been applied in one or more lighting fixtures 20.

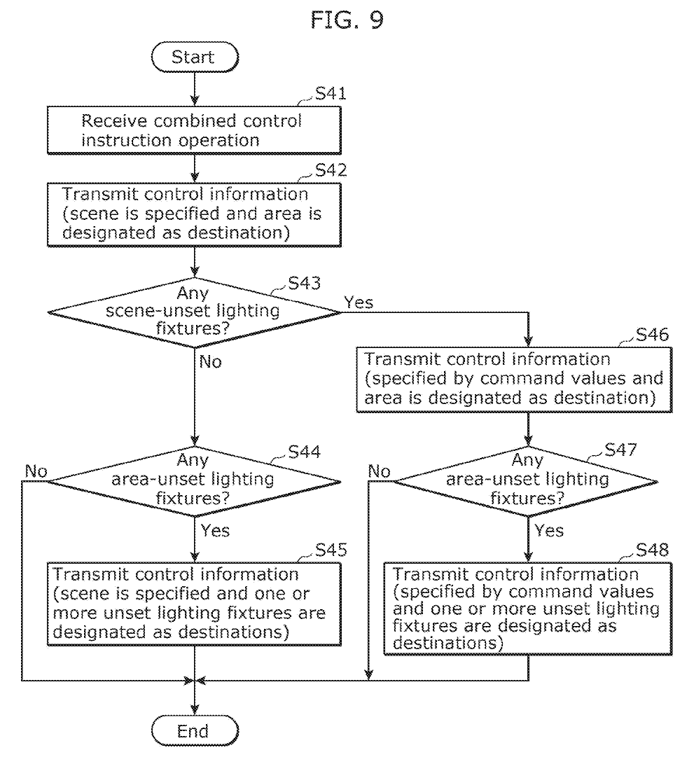

Therefore, control terminal 30 uses the setting management information to perform processing for causing one or more lighting fixtures 20 to which the area setting or the scene setting has not been applied to participate in the combined control. An example of such combined control will be described below. FIG. 9 is a flowchart illustrating an example of combined control.

The user performs combined control instruction operation to provide an instruction for combined control, and receiver 31 of control terminal 30 receives the combined control instruction operation (S41). The combined control instruction operation includes specifying area identification information (such as area 1) and specifying scene identification information (such as scene 1). Hereinafter, a specified area may also be referred to as a target area, and a specified scene may also be referred to as a target scene.

When the combined control instruction operation is received, information processor 34 transmits, by using wireless communicator 33, the control information in which the identification information of the target scene is specified and the target area is designated as a destination (S42). Note that, the control information in which the target area is designated as a destination specifies the area identification information of the target area.

As a result, lighting fixtures 20 belonging to the target area basically emit light (or stop emitting light) according to the content of the target scene. However, one or more lighting fixtures 20 to which at least one of the area setting or the scene setting has not been applied will not emit light (or stop emitting light) according to the content of the target scene.

Therefore, information processor 34 determines whether there are any lighting fixtures 20 to which the scene setting has not been applied (hereinafter, also referred to as one or more scene-unset lighting fixtures) (S43). Specifically, information processor 34 determines whether lighting fixtures 20 belonging to the target area in the area information (FIG. 4) stored in storage 35 include one or more lighting fixtures 20 in which a scene has not been set in the setting management information (FIG. 6).

When information processor 34 determines that there are no scene-unset lighting fixtures (No in S43), information processor 34 determines whether there are any lighting fixtures 20 to which the area setting has not been applied (hereinafter, also referred to as one or more area-unset lighting fixtures) (S44). Specifically, information processor 34 determines whether lighting fixtures 20 belonging to the target area in the area information (FIG. 4) stored in storage 35 include one or more lighting fixtures 20 in which the area has not been set in the setting management information (FIG. 6).

When information processor 34 determines that there are no area-unset lighting fixtures (No in S44), the operation ends. On the other hand, when information processor 34 determines that there are one or more area-unset lighting fixtures (Yes in S44), information processor 34 individually transmits, by using wireless communicator 33, control information to which the identification information of the target scene is specified, with the one or more area-unset lighting fixtures designated as destinations (S45). As a result, one or more lighting fixtures 20 that are area-unset lighting fixtures but not scene-unset lighting fixtures emit light (or stop emitting light) according to the content of the target control.

On the other hand, when information processor 34 determines that there are one or more scene-unset lighting fixtures in step S43 (Yes in S43), information processor 34 transmits, by using wireless communicator 33, control information in which the same control content as the target scene is specified by command values, with the target area designated as the destination (S46). Note that, in the control information with the target area designated as a destination, the area identification information of the target area is specified. As a result, one or more lighting fixtures 20 that are not area-unset lighting fixtures but are scene-unset lighting fixtures emit light (or stop emitting light) according to the content of the target control.

Moreover, information processor 34 determines whether there are any area-unset lighting fixtures (S47). The processing in step S47 is the same as the processing in step S44.

When information processor 34 determines that there are no area-unset lighting fixtures (No in S47), the operation ends. On the other hand, when information processor 34 determines that there are one or more area-unset lighting fixtures (Yes in S47), information processor 34 individually transmits, by using wireless communicator 33, control information in which the same control content as in the target scene is specified by command values, with the one or more scene-unset lighting fixtures designated as destinations (S48). As a result, one or more lighting fixtures 20 that are area-unset lighting fixtures and also scene-unset lighting fixtures emit light (or stop emitting light) according to the content of the target scene.

As described above, when the plurality of lighting fixtures 20 subject to combined control include one or more unset lighting fixtures to which at least one of the area setting or the scene setting has not been applied and control terminal 30 (information processor 34) instructs the plurality of lighting fixtures 20 to participate in the combined control to be performed by specifying the area identification information and the scene identification information, control terminal 30 (information processor 34) instructs the plurality of lighting fixtures 20 to participate in the combined control by using wireless communicator 33 (S42), and further instructs one or more unset lighting fixtures to participate in the same control as the combined control by using wireless communicator 33 (S45, S46, and S48).

With this, control terminal 30 can cause lighting fixtures 20 belonging to the target area to emit light (or stop emitting light) according to the content of the target scene, regardless of whether the area setting or the scene setting has been applied to lighting fixtures 20. In other words, control terminal 30 can achieve the combined control as intended by the user.

### Variation of Area Control

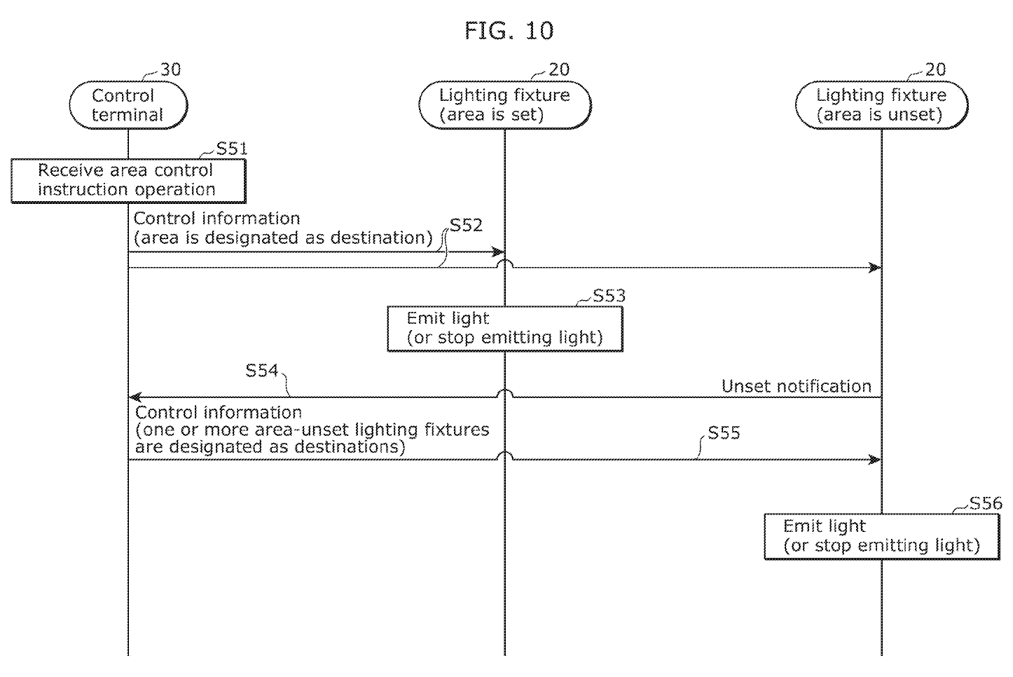

In the area control described above, whether there are any area-unset lighting fixtures is determined based on the setting management information. However, performing the determination based on the setting management information is not required. For example, when one or more area-unset lighting fixtures receive control information with the target area designated as a destination, the one or more area-unset lighting fixtures may transmit, to control terminal 30, an unset notification indicating that an area has not been set for the one or more area-unset lighting fixtures. With this, even when the setting management information is not stored in storage 35, control terminal 30 that has received the unset notification can detect one or more area-unset lighting fixtures. FIG. 10 is a sequence diagram illustrating a variation of such area control.

The user performs an area control instruction operation to provide an instruction for area control, and receiver 31 of control terminal 30 receives the area control instruction operation (S51). The area control instruction operation includes specifying the area identification information (e.g., area 1) and specifying the control content (e.g., turning on). Hereinafter, a specified area may also be referred to as a target area, and specified control content may also be referred to as target control.

When the area control instruction operation is received, information processor 34 transmits, by using wireless communicator 33, control information for performing the target control (control information in which the content of the target control is specified by command values), with the target area designated as a destination (S52). Note that, in the control information with the target area designated as a destination, the area identification information of the target area is specified.

When lighting fixtures 20 that belongs to the target area and in which an area has been set receive the control information, such lighting fixtures 20 basically emit light (or stop emitting light) according to the content of the target control (S53). On the other hand, one or more unset lighting fixtures to which area setting has not been applied (any lighting fixtures 20 in which area has not been set) will not emit light (or stop emitting light) according to the content of the target control even if the one or more unset lighting fixtures receive the control information. Here, in the present variation, each of the one or more area-unset lighting fixtures transmits an unset notification indicating that its area has not been set to control terminal 30 (S54).

Wireless communicator 33 of control terminal 30 receives the one or more unset notifications. Information processor 34 can detect one or more area-unset lighting fixtures based on the one or more unset notifications received. Information processor 34 that has detected the one or more area-unset lighting fixtures transmits, by using wireless communicator 33, control information for performing the target control, with the one or more area-unset lighting fixtures designated as destinations (S55).

When the one or more area-unset lighting fixtures receive the control information, the one or more area-unset lighting fixtures emit light (or stop emitting light) according to the content of the target control (S56).

As described above, after control terminal 30 instructs a plurality of lighting fixtures 20 to participate in the area control to be performed by specifying the area identification information, control terminal 30 receives, from one or more unset lighting fixtures, one or more unset notifications indicating that an area has not been set in the one or more unset lighting fixtures. Control terminal 30 (information processor 34) detects that the plurality of lighting fixtures 20 include one or more unset nodes to which a setting has not been applied, based on the one or more unset notifications received.

With this, control terminal 30 can detect one or more unset lighting fixtures without managing the presence or absence of unset lighting fixtures in advance using the setting management information or the like. Note that a variation similar to the present variation may be applied to the scene control or the combined control.

### Variation of Scene Control

In the scene control, when an old scene is set and a latest scene has not been set (scene setting has not been updated) in a scene-unset lighting fixture, lighting fixture 20 in which the latest scene is set performs a different operation (emits light or stops emitting light) from lighting fixture 20 in which an old scene is set.

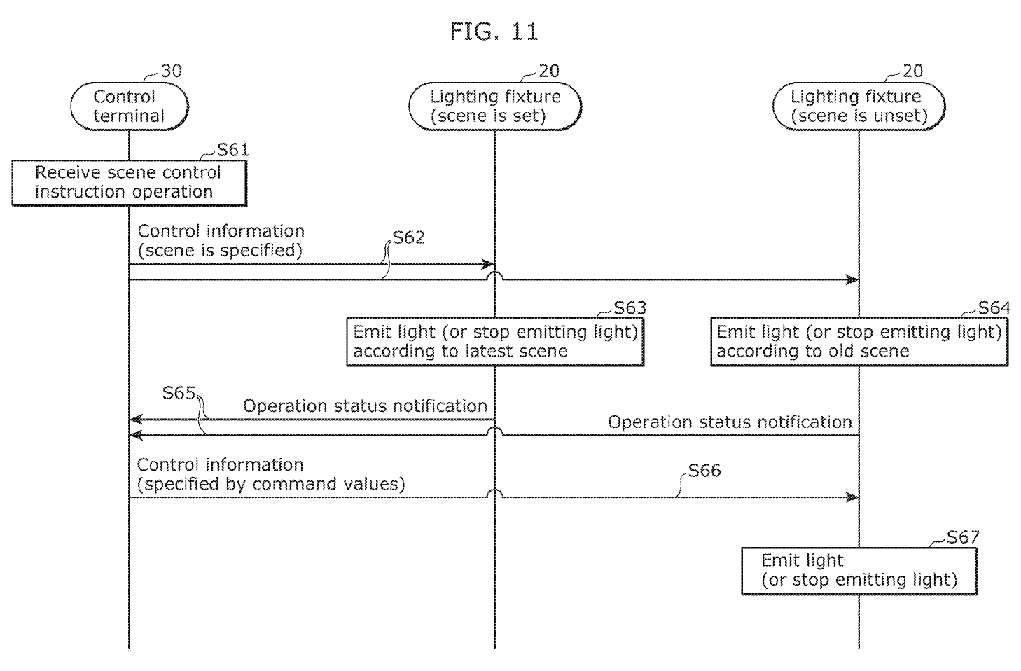

In such a case, each of lighting fixtures 20 that has operated based on the control information in which scene identification information is specified notifies control terminal 30 of its operation status. With this, control terminal 30 can detect lighting fixture 20 in which an old scene is set and instructs to participate in the same control as the control in the new scene to the detected lighting fixture 20. FIG. 11 is a sequence diagram illustrating a variation of such scene control. Note that, in the present variation, lighting fixture 20 to which the latest scene has not been applied and the old scene setting remains is referred to as a scene-unset lighting fixture.

The user performs a scene control instruction operation to provide an instruction for scene control, and receiver 31 of control terminal 30 receives the instruction operation for scene control (S61). The scene control instruction operation includes specifying a plurality of lighting fixtures 20 subject to the control and specifying scene identification information (such as scene 1). Hereinafter, the specified lighting fixtures 20 may also be referred to as target lighting fixtures, and the specified scene may also be referred to as a target scene.

When the scene control instruction operation is received, information processor 34 transmits, by using wireless communicator 33, the control information for performing the scene control (i.e., the control information in which the identification information of the target scene is specified), with the target lighting fixtures designated as destinations (S62). As a result, the target lighting fixtures basically emit light (or stop emitting light) according to the content of the target scene (S63). However, one or more target lighting fixtures to which the latest scene setting has not been applied will emit light (or stop emitting light) according to old content of scene control different from the target scene (S64).

Here, in the present variation, when each of the target lighting fixtures starts performing the scene control, the target lighting fixture transmits, to control terminal 30, an operation status notification indicating the operation status while performing the scene control (S65).

Wireless communicator 33 of control terminal 30 receives the operation status notifications. Information processor 34 can detect one or more scene-unset lighting fixtures (in this case, one or more lighting fixtures 20 to which the latest scene setting has not been applied and the old scene setting remains), based on the operation status notifications received. Information processor 34 that has detected one or more scene-unset lighting fixtures transmits, by using wireless communicator 33, the control information in which the same control content as the control content of the target scene is specified by command values, with the one or more scene-unset lighting fixtures designated as destinations (S66).

When the one or more scene-unset lighting fixtures receive the control information, the one or more scene-unset lighting fixtures emit light (or stop emitting light) according to the content of the target control (S67).

As described above, after control terminal 30 instructs a plurality of lighting fixtures 20 to participate in scene control to be performed by specifying scene identification information, control terminal 30 receives, from each of the plurality of lighting fixtures 20, an operation status notification indicating the operation status of each of the plurality of lighting fixtures 20. Control terminal 30 (information processor 34) detects that the plurality of lighting fixtures 20 include one or more unset lighting fixtures to which the latest setting has not been applied, based on the operation status notifications received.

With this, control terminal 30 can detect one or more unset lighting fixtures without managing the presence or absence of unset lighting fixtures in advance using the setting management information or the like. Note that a variation similar to the present variation may also be applied to the area control or the combined control.

### Providing Area information, Scene information, and Setting Management Information to Control device

The plurality of nodes forming the mesh network may include devices other than lighting fixtures 20. For example, a control device that is different from control terminal 30 and can control lighting fixtures 20 may be included. The control device is a device that receives an operation of a user and controls lighting fixtures 20 according to the received operation, for example. The control device may also be a scheduler that controls lighting fixtures 20 according to a preset schedule.

Here, information processor 34 of control terminal 30 may transmit (provide) area information, scene information, and setting management information (information indicating one or more unset lighting fixtures) to such a control device by using wireless communicator 33.

The control device that has received the area information, scene information, and setting management information from control terminal 30 can operate in the same manner as control terminal 30. In other words, when lighting fixtures 20 include one or more unset lighting fixtures, which are one or more lighting fixtures to which the area setting or the scene setting has not been applied, and the control device instructs lighting fixtures 20 to participate in control specified by area identification information or scene identification information, the control device can instruct lighting fixtures 20 to participate in the control through wireless communication and further instruct the one or more unset lighting fixtures to participate in the same control as the control through wireless communication.

### Variations

In the above embodiment, each of the nodes included in the mesh network is lighting fixture 20, but the nodes do not have to be lighting fixtures 20. The nodes may include one or more lighting fixtures 20 and other devices, or may include only other devices instead of lighting fixtures 20.

Examples of other devices may include a remote controller for lighting that is operated by a user to control lighting fixture 20, a pulse width modulation (PWM) dimmer, a scheduler, and an alternating current (AC) relay.

A PWM dimmer is a device capable of dimming lighting fixture 20 attached to the PWM dimmer. A scheduler is a device that turns on, turns off, or dims lighting fixtures 20 according to a preset schedule.

The AC relay includes two types, namely, a first AC relay and a second AC relay. The first AC relay is a device to be attached to a wiring duct and can turn on and off one device attached to the wiring duct by turning on and off the supply of AC power to the one device. The second AC relay is a device to be attached to the base of a wiring duct and can turn on and off all devices attached to the wire duct by turning on and off the supply of AC power to the wiring duct. Moreover, the AC relay may be, for example, a wireless control switch that does not use a wiring duct.

Moreover, the other devices may be devices that are not directly related to lighting, for example, an air conditioner, a ventilating device, a camera, a loudspeaker, a human presence sensor, an environmental sensor, or the like. Note that the environmental sensor may include a temperature sensor, a humidity sensor, a carbon dioxide concentration sensor, and a particulate matter (PM) sensor.

In the above embodiment, it has been described that control terminal 30 is not included in the mesh network, but control terminal 30 may be included in the mesh network. The following provides additional description for a transmission method for control information when control terminal 30 is not included in the mesh network. Information processor 34 of control terminal 30 may communicate with any one of lighting fixtures 20 by establishing one-to-one communication and transmitting a control signal to the one lighting fixture 20 by using wireless communicator 33. With this, control information can be transmitted to other lighting fixtures 20 through the one lighting fixture 20.

### Effects etc.

Hereinafter, examples of techniques that can be obtained from the disclosure in the present specification will be described together with effects etc. of the techniques.

Technique 1 is control terminal 30 includes: wireless communicator 33 that communicates with a plurality of devices; receiver 31 that receives, from a user, a setting related to identification information indicating a group to which the plurality of devices are to belong or control content to be instructed to the plurality of devices; and information processor 34 that, when the plurality of devices include an unset device to which the setting has not been applied and information processor 34 instructs the plurality of devices to participate in a first control to be performed by specifying the identification information, (a) instructs the plurality of devices to participate in the first control by using the wireless communicator and further (b) instructs the unset device to participate in same control as the first control by using wireless communicator 33.

Such control terminal 30 can include, as a target of the first control, a device in which the setting related to the identification information to be used for the first control has not been set by performing not only the processing in (a) but also the processing in (b).

Technique 2 is control terminal 30 according to Technique 1, in which receiver 31 receives a setting related to group identification information that is the identification information indicating the group, and the first control is performed by specifying the group identification information.

Such control terminal 30 can include, as a target of the group control, a device in which the setting related to the group identification information to be used for the group control has not been set.

Technique 3 is control terminal 30 according to Technique 1, in which receiver 31 receives a setting related to scene identification information that is the identification information indicating the control content, and the first control is performed by specifying the scene identification information.

Such control terminal 30 can include, as a target of the scene control, a device in which the setting related to the scene identification information to be used for the scene control has not been set.

Technique 4 is control terminal 30 according to Technique 1, in which receiver 31 receives both a setting related to group identification information and a setting related to scene identification information, the group identification information being the identification information indicating the group, the scene identification information being the identification information indicating the control content, and the first control is performed by specifying the group identification information and the scene identification information.

Such control terminal 30 can include, as a target of the combined control, a device in which the setting related to the group identification information and the setting related to the scene identification information that are to be used for the combined control have not been set.

Technique 5 is control terminal 30 according to any one of Techniques 1 to 4, in which information processor 34 transmits, by using wireless communicator 33, information indicating the unset device to a control device that is different from control terminal 30 and is configured to control the plurality of devices. The information indicating the unset device is, for example, setting management information in the above-described embodiment.

Such control terminal 30 can support the control device to perform the processing in (b) described above.

Technique 6 is control terminal 30 according to Technique 2 or 4, in which after control terminal 30 instructs the plurality of devices to participate in the first control to be performed by specifying the group identification information, wireless communicator 33 receives, from the unset device, an unset notification indicating that a group has not been set for the unset device, and information processor 34 detects that the plurality of devices include an unset device to which the setting has not been applied, based on the unset notification received.

Such control terminal 30 can detect one or more unset devices without managing the presence or absence of one or more unset devices in advance.

Technique 7 is control terminal 30 according to any one of Techniques 1 to 6, in which after control terminal 30 instructs the plurality of devices to participate in the first control to be performed by specifying the scene identification information, wireless communicator 33 receives, from each of the plurality of devices, an operation status notification indicating an operation status of the device, and information processor 34 detects that the plurality of devices include an unset device to which the setting has not been applied, based on the operation status notifications received.

Such control terminal 30 can detect one or more unset devices without managing the presence or absence of one or more unset devices in advance.

Technique 8 is control terminal 30 according to any one of Techniques 1 to 7, in which the plurality of devices include lighting fixture 20.

Such control terminal 30 can control lighting fixture 20.

Technique 9 is device control system 10 including: control terminal 30 according to any one of Techniques 1 to 8; and the plurality of devices.

Such device control system 10 can include, as a target of the first control, the device in which the setting related to the identification information to be used for the first control has not been set by performing not only the processing in (a) but also the processing in (b).

Technique 10 is a control method executed by control terminal 30 that communicates wirelessly with a plurality of devices; receiving, from a user, a setting related to identification information indicating a group to which the plurality of devices are to belong or control content to be instructed to the plurality of devices; and when the plurality of devices include an unset device to which the setting has not been applied and the plurality of devices are instructed to participate in a first control to be performed by specifying the identification information, (a) instructing the plurality of devices to participate in the first control through wireless communication and further (b) instructing the unset device to participate in same control as the first control through the wireless communication.

Such a control method can include, as a target of the first control, the device in which the setting related to the identification information to be used for the first control has not been set by performing not only the processing in (a) but also the processing in (b).

Technique 11 is a program for causing control terminal 30 to execute the control method according to Technique 10.

Such a program enables control terminal 30 to include, as a target of the first control, a device in which the setting related to the identification information to be used for the first control has not been set by performing not only the processing in (a) but also the processing in (b).

### Other embodiments

Although an exemplary embodiment has been described above, the present disclosure should not be construed to be limited to the embodiment described above.

For example, in the above embodiment, the processes performed by a certain processing unit may be performed by another processing unit. Furthermore, the order of processes may be changed, or the processes may be executed in parallel.

Moreover, in the embodiment described above, the structural elements may be achieved by executing software programs suitable for the structural elements. Each of the structural elements may be achieved by a program executor, such as a central processing unit (CPU) or a processor, reading out the software programs stored in a recording medium, such as a hard disk or a semiconductor memory, and executing the read-out programs.

Moreover, each of the structural elements may be achieved by hardware. For example, the structural element such as a controller may be a circuit (or integrated circuit). Such circuits may be configured as a single circuit as a whole, and may be separate circuits. Moreover, such circuits may each be a general-purpose circuit or a dedicated circuit.

Moreover, the general or specific aspects of the present disclosure may be implemented using a system, a device, a method, an integrated circuit, a computer program, or a computer-readable recording medium, such as a compact disc read-only memory (CD-ROM), or any combination of systems, devices, methods, integrated circuits, computer programs, or recording media.

For example, the present disclosure may be implemented as a device control system or a control terminal according to the embodiment described above, or as a control method to be executed by the control terminal. The present disclosure may be implemented as a program for causing the control terminal (computer) to execute such a control method, or as a non-transitory computer-readable recoding medium having such a program recorded thereon. Stated differently, the program is a computer program product. Such a program includes an application program for enabling a computer, such as a general-purpose information terminal, to function as the control terminal according to the embodiment described above.

Other embodiments implemented through various changes and modifications conceived by a person of ordinary skill in the art based on the above one or more embodiments or through a combination of the structural elements in the one or more embodiments in any manner without departing from the scope of the present disclosure may be included in the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A control terminal comprising:
a wireless communicator that communicates with a plurality of devices;
a receiver that receives, from a user, a setting related to identification information indicating a group to which the plurality of devices are to belong or control content to be instructed to the plurality of devices; and
an information processor that, when the plurality of devices include an unset device to which the setting has not been applied and the information processor instructs the plurality of devices to participate in a first control to be performed by specifying the identification information, (a) instructs the plurality of devices to participate in the first control by using the wireless communicator and further (b) instructs the unset device to participate in same control as the first control by using the wireless communicator.

2. The control terminal according to claim 1, wherein
the receiver receives a setting related to group identification information that is the identification information indicating the group, and
the first control is performed by specifying the group identification information.

3. The control terminal according to claim 1, wherein
the receiver receives a setting related to scene identification information that is the identification information indicating the control content, and
the first control is performed by specifying the scene identification information.

4. The control terminal according to claim 1, wherein
the receiver receives both a setting related to group identification information and a setting related to scene identification information, the group identification information being the identification information indicating the group, the scene identification information being the identification information indicating the control content, and
the first control is performed by specifying the group identification information and the scene identification information.

5. The control terminal according to claim 1, wherein
the information processor transmits, by using the wireless communicator, information indicating the unset device to a control device that is different from the control terminal and is configured to control the plurality of devices.

6. The control terminal according to claim 2, wherein
after the control terminal instructs the plurality of devices to participate in the first control to be performed by specifying the group identification information, the wireless communicator receives, from the unset device, an unset notification indicating that a group has not been set for the unset device, and
the information processor detects that the plurality of devices include an unset device to which the setting has not been applied, based on the unset notification received.

7. The control terminal according to claim 1, wherein
after the control terminal instructs the plurality of devices to participate in the first control to be performed by specifying the scene identification information, the wireless communicator receives, from each of the plurality of devices, an operation status notification indicating an operation status of the device, and
the information processor detects that the plurality of devices include an unset device to which the setting has not been applied, based on the operation status notifications received.

8. The control terminal according to claim 1, wherein
the plurality of devices include a lighting fixture.

9. A device control system comprising:
the control terminal according to claim 1; and
the plurality of devices.

10. A control method executed by a control terminal that communicates wirelessly with a plurality of devices;
receiving, from a user, a setting related to identification information indicating a group to which the plurality of devices are to belong or control content to be instructed to the plurality of devices; and
when the plurality of devices include an unset device to which the setting has not been applied and the plurality of devices are instructed to participate in a first control to be performed by specifying the identification information, (a) instructing the plurality of devices to participate in the first control through wireless communication and further (b) instructing the unset device to participate in same control as the first control through the wireless communication.

11. A non-transitory computer-readable recording medium having a program recorded thereon for causing the control terminal to execute the control method according to claim 10.
